(19) United States
(12) Patent Application Publication
(10) Pub. No.: US 2019/0005523 A1
(43) Pub. Date: Jan. 3, 2019

(54) IDENTIFYING CHANGES IN ESTIMATED ACTIONS PERFORMED BY USERS PRESENTED WITH A CONTENT ITEM RELATIVE TO DIFFERENT BUDGETS FOR PRESENTING THE CONTENT ITEM

(71) Applicant: Facebook, Inc., Menlo Park, CA (US)

(72) Inventors: Ori Hanegby, Saratoga, CA (US); Ruoyu Zhang, Morgan Hill, CA (US); Cheran Wu, Foster City, CA (US); Jie Xu, Foster City, CA (US); Daozheng Chen, San Jose, CA (US); Joshua Elliot Geller, Mountain View, CA (US); Vighnesh Avadhani, Santa Clara, CA (US); Zhen Yao, Palo Alto, CA (US)

(21) Appl. No.: 15/636,631

(22) Filed: Jun. 28, 2017

(51) Int. Cl. G06Q 30/02; G06Q 10/04

(52) U.S. Cl. CPC G06Q 30/0206; G06Q 10/04; G06Q 30/02; G06Q 10/043; G06Q 30/0201

(57) ABSTRACT

An online system receives a content item and budget for presenting the content item from a publishing user, and estimates certain interactions by users presented with the content item if the budget is increased. The online system applies one or more models to the received budget to estimate one or more interactions with the content item for different increased budgets. The online system presents the estimated interactions and different increased budgets to the publishing user. To encourage the publishing user to increase the budget, the online system may present estimated interactions by users corresponding to different increased budgets when the publishing user provides the content item to the online system. The online system may limit presentation of estimated interactions for increased budgets to increased budgets for which the online system estimated interactions with at least a threshold accuracy and may identify an increased budget optimizing a number of estimated interactions.

### BACKGROUND

This disclosure relates generally to presenting content to users of an online system, and more specifically to providing a publishing user with information identifying estimated actions by users when different budgets are used to present the content item to users.

Online systems, such as social networking systems, allow users to connect to and to communicate with other users of the online system. Users may create profiles on an online system that are tied to their identities and include information about the users, such as interests and demographic information. The users may be individuals or entities such as corporations or charities. Online systems allow users to easily communicate and to share content with other online system users by providing content to an online system for presentation to other users. Content provided to an online system by a user may be declarative information provided by a user, status updates, check-ins to locations, images, photographs, videos, text data, or any other information a user wishes to share with additional users of the online system. An online system may also generate content for presentation to a user, such as content describing actions taken by other users on the online system.

Additionally, many online systems commonly allow publishing users (e.g., businesses) to sponsor presentation of content on an online system to gain public attention for a user's products or services or to persuade other users to take an action regarding the publishing user's products or services. Content for which the online system receives compensation in exchange for presenting to users is referred to as “sponsored content.” Many online systems receive compensation from a publishing user for presenting online system users with certain types of sponsored content provided by the publishing user. Frequently, online systems charge a publishing user for each presentation of sponsored content to an online system user or for each interaction with sponsored content by an online system user. For example, an online system receives compensation from a publishing user each time a content item provided by the publishing user is displayed to another user on the online system or each time another user is presented with a content item on the online system and interacts with the content item (e.g., selects a link included in the content item), or each time another user performs another action after being presented with the content item.

Various publishing users may provide the online system with budgets for presenting content received from the publishing user to other online system users. A budget allows a publishing user to specify a maximum amount of compensation provided to the online system during a time interval for presenting one or more content items from the publishing user to other users. However, many publishing users have limited information about how different budgets may influence effectiveness of users performing actions desired by the publishing users when presented with content items via an online system. For example, many publishing users base a budget for presenting a content item on historical amounts allocated by the publishing user for content presentation through an online system, with limited information regarding possible actions by users from current presentation of content via the online system.

### SUMMARY

An online system receives a content item from a publishing user for presentation to one or more users of the online system. The content item includes content for presentation to users and a bid amount specifying an amount of compensation the publishing user provides the online system when the content item is presented to a user or when a user to whom the content item was presented performs a particular action. For example, the bid amount specifies a maximum amount of compensation the publishing user provides the online system each time the content item is presented to a user. As another example, the bid amount specifies a maximum amount of compensation the publishing user provides the online system for each specific interaction performed by a user to whom the content item was presented. In various embodiments, the content item includes an objective specifying an action the publishing user desires a user to perform after being presented with the content item, so the bid amount indicates a maximum amount of compensation the publishing user provides the online system when a user presented with the content item performs the action specified by the objective.

Additionally, the online system receives a budget associated with the content item from the publishing user. The budget specifies a maximum amount of compensation the publishing user provides the online system for presenting the content item to users during a specific time interval. For example, the budget specifies a maximum amount of compensation the online system receives from the publishing user during a one month time interval in exchange for presentation of the content item to users during the one month time interval. When the online system receives an amount of compensation from the publishing user during the specific time interval of the budget, the online system withholds subsequent presentation of the content item to users during the specific time interval. Hence, the budget allows the publishing user to limit an amount provided to the online system for presenting the content item.

However, the publishing user often has limited information for determining the budget associated with the content item, which may limit the effectiveness of presentation of the content item enticing online system users to perform actions when presented with the content item. For example, the publishing user specifies a low amount for a budget for presenting the content item, reducing a number of times the content item is presented to users by the online system. If the content item is successful in causing users to perform actions after presentation, the low budget limits a number of actions performed by users by limiting a number of users to whom the content item was presented during the specific time interval corresponding to the budget. Conversely, if a content item is ineffective in causing users to perform actions after presentation, the publishing user may specify a budget that is too large, which causes the publishing user to provide the online system with compensation that is disproportionate to the number of actions performed by users who were presented with the content item during the specific time interval.

To allow the publishing user to refine the budget associated with the content item, the online system leverages information about online system users and content items presented to the online system users to provide the publishing user with estimated actions performed by users to whom the content item was presented. By presenting the publishing user with the estimated actions, the online system allows the publishing user to refine the budget for presenting the content item during a specific time interval to most effectively present the content item to users to encourage user actions. The online system 140 identifies a set of users eligible to be presented with the content item and determines a set of alternative budgets associated with the content item, with each alternative budget differing from the received budget. In various embodiments, each alternative budget is greater than the budget received from the publishing user and associated with the content item. Alternatively, the alternative budgets of the set are both greater than and less than the budget a that are each greater than the budget received from the publishing user and associated with the content item. Each alternative budget corresponds to the specific time interval specified by the budget.

For each of the alternative budgets and for the budget, the online system determines an estimated number of actions performed by users when presented with the content item. To determine the estimated number of actions for an alternative budget or for the budget, the online system applies one or more models to characteristics of users of the identified set, characteristics of the content item, and the alternative budget (or the budget). The one or more models are machine learned models trained from prior presentation of content items to various online system users, and estimate whether a user presented with the content item performs one or more actions based on characteristics of the users and characteristics of the content item, while accounting for a budget that limits presentation of the content item during the specific time interval. The one or more models may be trained using any suitable technique, and may use any suitable combination of characteristics of users or characteristics of the content item to predict whether a user of the set would perform an action after being presented with the content item. In various embodiments, the online system determines an estimated number of an action specified by an objective included in the particular content item specifying actions for each of multiple alternative budgets.

The online system communicates information identifying each alternative budget and the estimated number of actions associated with each alternative budget to a client device for presentation to the publishing user. In various embodiments, the online system communicates a graph illustrating different alternative budgets with their corresponding estimated number of actions. The information communicated to the client device identifies the budget received from the publishing user as well as the estimated number of actions corresponding to the budget received from the publishing user in various embodiments, allowing the publishing user to more easily identify changes in the estimated number of actions for alternative budgets relative to the estimated number of actions for the budget.

In various embodiments, the online system determines an accuracy of the model for estimating actions performed by users and communicates the information identifying the budget and alternative budgets in association with their corresponding estimated numbers of actions to the client device in response to the accuracy of the model equaling or exceeding a threshold. If the accuracy of the model is less than the threshold, the online system withholds communication of the information identifying the budget and additional budgets, as well as their corresponding estimated actions, to the client device. This allows the online system to limit presentation of estimated numbers of actions corresponding to different budgets to numbers of actions that have been determined with at least a threshold accuracy, limiting information provided to the publishing user to estimated numbers of actions most likely to provide the publishing user with information most likely to accurately estimate actions performed by users to whom the content item is presented.

Additionally, the online system may identify an optimum alternative budget of the set to the publishing user in various embodiments. The optimum alternative budget corresponds to a maximum number of estimated actions occurring before increased alternative budgets correspond to decreased numbers of estimated actions, allowing the online system to identify an alternative budget estimated to result in an optimum number of actions for the publishing user when used to present the content item to users. To identify the optimum alternative budget, the online system determines rates of changes of the estimated number of actions with respect to changes in the alternative budget. For example, the online system determines values derivative of a function of the estimated number of actions based on the alternative budgets for different alternative budgets. Based on the determined rates of change of the estimated number of actions, the online system identifies the optimum alternative budget of the set of alternative budgets. In various embodiments, the online system identifies the optimum alternative budget by selecting an alternative budget associated with a rate of change of the estimated number of actions that is less than a threshold value and determines a rate at which the rate of change of the estimated number of actions associated with the selected alternative budget changes. If the rate at which the rate of change of the estimated number of actions associated with the selected alternative budget changes is less than a threshold rate of change, the online system identifies the selected alternative budget as the optimum budget.

### BRIEF DESCRIPTION OF THE DRAWINGS

FIG. 1 is a block diagram of a system environment in which an online system operates, in accordance with an embodiment.

FIG. 2 is a block diagram of an online system, in accordance with an embodiment.

FIG. 3 is a flowchart of a method for identifying estimated actions from presentation of a content item associated with a budget for alternative budgets, in accordance with an embodiment.

FIG. 4 is an example of information presented to a publishing user identifying different budgets 405 and corresponding estimated numbers of actions for presenting a content item, in accordance with an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Architecture

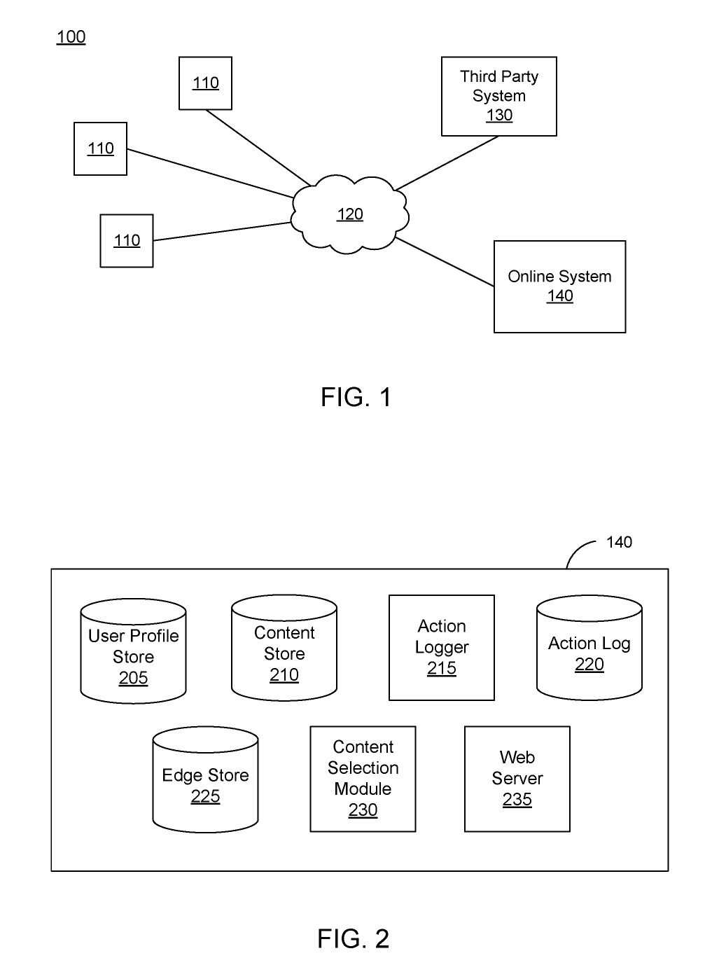

FIG. 1 is a block diagram of a system environment 100 for an online system 140. The system environment 100 shown by FIG. 1 comprises one or more client devices 110, a network 120, one or more third-party systems 130, and the online system 140. In alternative configurations, different and/or additional components may be included in the system environment 100. For example, the online system 140 is a social networking system, a content sharing network, or another system providing content to users.

The client devices 110 are one or more computing devices capable of receiving user input as well as transmitting and/or receiving data via the network 120. In one embodiment, a client device 110 is a conventional computer system, such as a desktop or a laptop computer. Alternatively, a client device 110 may be a device having computer functionality, such as a personal digital assistant (PDA), a mobile telephone, a smartphone, a smartwatch, or another suitable device. A client device 110 is configured to communicate via the network 120. In one embodiment, a client device 110 executes an application allowing a user of the client device 110 to interact with the online system 140. For example, a client device 110 executes a browser application to enable interaction between the client device 110 and the online system 140 via the network 120. In another embodiment, a client device 110 interacts with the online system 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more third party systems 130 may be coupled to the network 120 for communicating with the online system 140, which is further described below in conjunction with FIG. 2. In one embodiment, a third party system 130 is an application provider communicating information describing applications for execution by a client device 110 or communicating data to client devices 110 for use by an application executing on the client device. In other embodiments, a third party system 130 provides content or other information for presentation via a client device 110. A third party system 130 may also communicate information to the online system 140, such as advertisements, content, or information about an application provided by the third party system 130.

Various third party systems 130 provide content to users of the online system 140. For example, a third party system 130 maintains pages of content that users of the online system 140 may access through one or more applications executing on a client device 110. The third party system 130 may provide content items to the online system 140 identifying content provided by the online system 140 to notify users of the online system 140 of the content provided by the third party system 130. For example, a content item provided by the third party system 130 to the online system 140 identifies a page of content provided by the online system 140 that specifies a network address for obtaining the page of content. If the online system 140 presents the content item to a user who subsequently accesses the content item via a client device 110, the client device 110 obtains the page of content from the network address specified in the content item. This allows the user to more easily access the page of content.

FIG. 2 is a block diagram of an architecture of the online system 140. The online system 140 shown in FIG. 2 includes a user profile store 205, a content store 210, an action logger 215, an action log 220, an edge store 225, a content selection module 230, and a web server 235. In other embodiments, the online system 140 may include additional, fewer, or different components for various applications. Conventional components such as network interfaces, security functions, load balancers, failover servers, management and network operations consoles, and the like are not shown so as to not obscure the details of the system architecture.

Each user of the online system 140 is associated with a user profile, which is stored in the user profile store 205. A user profile includes declarative information about the user that was explicitly shared by the user and may also include profile information inferred by the online system 140. In one embodiment, a user profile includes multiple data fields, each describing one or more attributes of the corresponding social networking system user. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with information identifying the social networking system users displayed in an image, with information identifying the images in which a user is tagged stored in the user profile of the user. A user profile in the user profile store 205 may also maintain references to actions by the corresponding user performed on content items in the content store 210 and stored in the action log 220.

Each user profile includes user identifying information allowing the online system 140 to uniquely identify users corresponding to different user profiles. For example, each user profile includes an electronic mail (“email”) address, allowing the online system 140 to identify different users based on their email addresses. However, a user profile may include any suitable user identifying information associated with users by the online system 140 that allows the online system 140 to identify different users.

While user profiles in the user profile store 205 are frequently associated with individuals, allowing individuals to interact with each other via the online system 140, user profiles may also be stored for entities such as businesses or organizations. This allows an entity to establish a presence on the online system 140 for connecting and exchanging content with other social networking system users. The entity may post information about itself, about its products or provide other information to users of the online system 140 using a brand page associated with the entity's user profile. Other users of the online system 140 may connect to the brand page to receive information posted to the brand page or to receive information from the brand page. A user profile associated with the brand page may include information about the entity itself, providing users with background or informational data about the entity.

The content store 210 stores objects that each represent various types of content. Examples of content represented by an object include a page post, a status update, a photograph, a video, a link, a shared content item, a gaming application achievement, a check-in event at a local business, a brand page, or any other type of content. Online system users may create objects stored by the content store 210, such as status updates, photos tagged by users to be associated with other objects in the online system 140, events, groups or applications. In some embodiments, objects are received from third party applications or third party applications separate from the online system 140. In one embodiment, objects in the content store 210 represent single pieces of content, or content “items.” Hence, online system users are encouraged to communicate with each other by posting text and content items of various types of media to the online system 140 through various communication channels. This increases the amount of interaction of users with each other and increases the frequency with which users interact within the online system 140.

One or more content items included in the content store 210 include content for presentation to a user and a bid amount. Content presented to a user may be text, image, audio, video, or any other suitable data. In various embodiments, the content also specifies a page of content. For example, a content item includes a landing page specifying a network address of a page of content to which a user is directed when the content item is accessed. The bid amount is included in a content item by a publishing user and is used to determine an expected value, such as monetary compensation, provided by the publishing user to the online system 140 if content in the content item is presented to a user, if the content in the content item receives particular interaction from a user when presented, or if any suitable condition is satisfied when content in the content item is presented to a user. For example, the bid amount included in a content item specifies a monetary amount that the online system 140 receives from the publishing user if content in the content item is displayed. In some embodiments, the expected value to the online system 140 of presenting the content from the content item may be determined by multiplying the bid amount by a probability of the content of the content item being accessed by a user.

Various content items may include an objective identifying an interaction that the publishing user providing the content item to the online system 140 desires other users to perform when presented with content included in the content item. Example objectives include: installing an application associated with a content item, indicating a preference for a content item, sharing a content item with other users, interacting with an object associated with a content item, or performing any other suitable interaction. As content from a content item is presented to online system users, the online system 140 logs interactions between users presented with the content item or with objects associated with the content item. Additionally, the online system 140 receives compensation from the publishing user associated with content item as online system users perform interactions with a content item that satisfy the objective included in the content item.

In various embodiments, the online system 140 receives a budget for presenting the content item from the publishing user. The budget specifies a maximum amount of compensation the publishing user provides the online system 140 during a specific time interval for presenting the content item to other users. When presenting the content item to users, the online system 140 presents the content item until the online system 140 receives an amount of compensation from the publishing user equaling the budget. After receiving an amount of compensation form the publishing user equaling the budget, the online system 140 withholds presentation of the content item to other users during the specific time interval specified by the budget.

Additionally, a content item may include one or more targeting criteria specified by the publishing user who provided the content item to the online system 140. Targeting criteria included in a content item request specify one or more characteristics of users eligible to be presented with the content item. For example, targeting criteria are used to identify users having user profile information, edges, or actions satisfying at least one of the targeting criteria. Hence, targeting criteria allow the publishing user to identify users having specific characteristics, simplifying subsequent distribution of content to different users.

In one embodiment, targeting criteria may specify actions or types of connections between a user and another user or object of the online system 140. Targeting criteria may also specify interactions between a user and objects performed external to the online system 140, such as on a third party system 130. For example, targeting criteria identifies users that have taken a particular action, such as sent a message to another user, used an application, joined a group, left a group, joined an event, generated an event description, purchased or reviewed a product or service using an online marketplace, requested information from a third party system 130, installed an application, or performed any other suitable action. Including actions in targeting criteria allows users to further refine users eligible to be presented with content items. As another example, targeting criteria identifies users having a connection to another user or object or having a particular type of connection to another user or object.

The action logger 215 receives communications about user actions internal to and/or external to the online system 140, populating the action log 220 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with the particular users as well and stored in the action log 220.

The action log 220 may be used by the online system 140 to track user actions on the online system 140, as well as actions on third party systems 130 that communicate information to the online system 140. Users may interact with various objects on the online system 140, and information describing these interactions is stored in the action log 220. Examples of interactions with objects include: commenting on posts, sharing links, checking-in to physical locations via a client device 110, accessing content items, and any other suitable interactions. Additional examples of interactions with objects on the online system 140 that are included in the action log 220 include: commenting on a photo album, communicating with a user, establishing a connection with an object, joining an event, joining a group, creating an event, authorizing an application, using an application, expressing a preference for an object (“liking” the object), and engaging in a transaction. Additionally, the action log 220 may record a user's interactions with advertisements on the online system 140 as well as with other applications operating on the online system 140. In some embodiments, data from the action log 220 is used to infer interests or preferences of a user, augmenting the interests included in the user's user profile and allowing a more complete understanding of user preferences.

The action log 220 may also store user actions taken on a third party system 130, such as an external website, and communicated to the online system 140. For example, an e-commerce website may recognize a user of an online system 140 through a social plug-in enabling the e-commerce website to identify the user of the online system 140. Because users of the online system 140 are uniquely identifiable, e-commerce web sites, such as in the preceding example, may communicate information about a user's actions outside of the online system 140 to the online system 140 for association with the user. Hence, the action log 220 may record information about actions users perform on a third party system 130, including webpage viewing histories, advertisements or other content with which the user engaged, purchases made, and other patterns from shopping and buying. Hence, the action log 220 may include information identifying content provided by one or more third party systems 130 that a user of the online system 140 has accessed or content provided by one or more third party systems 130 with which the user of the online system 140 otherwise interacted. Various third party systems 130 may include tracking mechanisms in content comprising instructions that, when executed by a client device 110, provide information identifying the content and identifying a user of the online system 140 associated with the client device 110 to the online system 140. In various embodiments, the information provided by the tracking mechanism identifies one or more products associated with a third party system 130 and include in, or otherwise associated with, the identified content. The information identifying the content is stored in the action log 220 in association with information identifying the user to the online system 140. Additionally, actions a user performs via an application associated with a third party system 130 and executing on a client device 110 may be communicated to the action logger 215 by the application for recordation and association with the user in the action log 220.

In one embodiment, the edge store 225 stores information describing connections between users and other objects on the online system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the online system 140, such as expressing interest in a page on the online system 140, sharing a link with other users of the online system 140, and commenting on posts made by other users of the online system 140.

An edge may include various features each representing characteristics of interactions between users, interactions between users and objects, or interactions between objects. For example, features included in an edge describe a rate of interaction between two users, how recently two users have interacted with each other, a rate or an amount of information retrieved by one user about an object, or numbers and types of comments posted by a user about an object. The features may also represent information describing a particular object or user. For example, a feature may represent the level of interest that a user has in a particular topic, the rate at which the user logs into the online system 140, or information describing demographic information about the user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the online system 140 over time to approximate a user's interest in an object or in another user in the online system 140 based on the actions performed by the user. A user's affinity may be computed by the online system 140 over time to approximate the user's interest in an object, in a topic, or in another user in the online system 140 based on actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

The content selection module 230 selects one or more content items for communication to a client device 110 to be presented to a user. Content items eligible for presentation to the user are retrieved from the content store 210 or from another source by the content selection module 230, which selects one or more of the content items for presentation to the viewing user. A content item eligible for presentation to the user is a content item associated with at least a threshold number of targeting criteria satisfied by characteristics of the user or is a content item that is not associated with targeting criteria. In various embodiments, the content selection module 230 includes content items eligible for presentation to the user in one or more selection processes, which identify a set of content items for presentation to the user. For example, the content selection module 230 determines measures of relevance of various content items to the user based on characteristics associated with the user by the online system 140 and based on the user's affinity for different content items. Based on the measures of relevance, the content selection module 230 selects content items for presentation to the user. As an additional example, the content selection module 230 selects content items having the highest measures of relevance or having at least a threshold measure of relevance for presentation to the user. Alternatively, the content selection module 230 ranks content items based on their associated measures of relevance and selects content items having the highest positions in the ranking or having at least a threshold position in the ranking for presentation to the user.

Content items eligible for presentation to the user may include content items associated with bid amounts. The content selection module 230 uses the bid amounts associated with ad requests when selecting content for presentation to the user. In various embodiments, the content selection module 230 determines an expected value associated with various content items based on their bid amounts and selects content items associated with a maximum expected value or associated with at least a threshold expected value for presentation. An expected value associated with a content item represents an expected amount of compensation to the online system 140 for presenting the content item. For example, the expected value associated with a content item is a product of the ad request's bid amount and a likelihood of the user interacting with the content item. The content selection module 230 may rank content items based on their associated bid amounts and select content items having at least a threshold position in the ranking for presentation to the user. In some embodiments, the content selection module 230 ranks both content items not associated with bid amounts and content items associated with bid amounts in a unified ranking based on bid amounts and measures of relevance associated with content items. Based on the unified ranking, the content selection module 230 selects content for presentation to the user. Selecting content items associated with bid amounts and content items not associated with bid amounts through a unified ranking is further described in U.S. patent application Ser. No. 13/545,266, filed on Jul. 10, 2012, which is hereby incorporated by reference in its entirety.

For example, the content selection module 230 receives a request to present a feed of content to a user of the online system 140. The feed may include one or more content items associated with bid amounts and other content items that are not associated with bid amounts, such as stories describing actions associated with other online system users connected to the user. The content selection module 230 accesses one or more of the user profile store 205, the content store 210, the action log 220, and the edge store 225 to retrieve information about the user. For example, information describing actions associated with other users connected to the user or other data associated with users connected to the user are retrieved. Content items from the content store 210 are retrieved and analyzed by the content selection module 230 to identify candidate content items eligible for presentation to the user. For example, content items associated with users who not connected to the user or stories associated with users for whom the user has less than a threshold affinity are discarded as candidate content items. Based on various criteria, the content selection module 230 selects one or more of the content items identified as candidate content items for presentation to the identified user. The selected content items are included in a feed of content that is presented to the user. For example, the feed of content includes at least a threshold number of content items describing actions associated with users connected to the user via the online system 140.

In various embodiments, the content selection module 230 presents content to a user through a newsfeed including a plurality of content items selected for presentation to the user. One or more content items may also be included in the feed. The content selection module 230 may also determine the order in which selected content items are presented via the feed. For example, the content selection module 230 orders content items in the feed based on likelihoods of the user interacting with various content items.

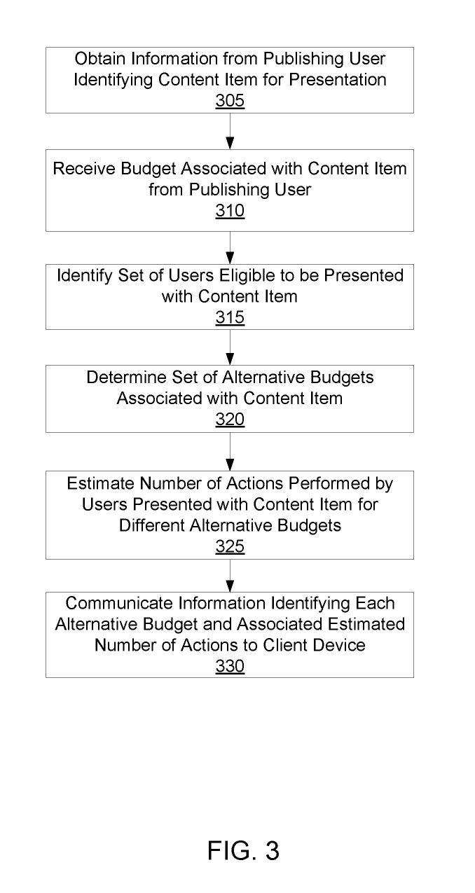

In various embodiments, the content selection module 230 provides a publishing user with predicted numbers of interactions for a content item associated with a budget for various alternative budgets. As further described below in conjunction with FIG. 3, when the online system 140 receives a content item and a budget associated with the content item, the content selection module 230 identifies a set of users and various alternative budgets. In various embodiments, each of the alternative budgets is greater than the received budget. For each of at least a set of the alternative budgets, the online system 140 applies one or more models to an alternative budget, characteristics of the content item, and characteristics of at least a set of users. The one or more models estimate a number of one or more actions that users of the set would perform if presented with the content item when associated with an alternative budget. The content selection module 230 provides information to the publishing user identifying the estimated number of actions for presenting the content item to users subject to different alternative budget, allowing the publishing user to more readily determine effects of increasing the budget for presenting the content item on actions performed by users to whom the content item is presented, as further described below in conjunction with FIG. 3.

The web server 235 links the online system 140 via the network 120 to the one or more client devices 110, as well as to the one or more third party systems 130. The web server 235 serves web pages, as well as other content, such as JAVA®, FLASH®, XML and so forth. The web server 235 may receive and route messages between the online system 140 and the client device 110, for example, instant messages, queued messages (e.g., email), text messages, short message service (SMS) messages, or messages sent using any other suitable messaging technique. A user may send a request to the web server 235 to upload information (e.g., images or videos) that are stored in the content store 210. Additionally, the web server 235 may provide application programming interface (API) functionality to send data directly to native client device operating systems, such as IOS®, ANDROID™, or BlackberryOS.

Identifying Estimated Actions by Users from Presentation of a Content Item with Alternative Budgets

FIG. 3 is a flowchart of one embodiment of a method for identifying estimated actions from presentation of a content item associated with a budget for alternative budgets. In other embodiments, the method may include different and/or additional steps than those shown in FIG. 3. Additionally, steps of the method may be performed in different orders than the order described in conjunction with FIG. 3 in various embodiments.

An online system 140 obtains 305 information from a publishing user identifying a content item for presentation to users of the online system 140. As further described above in conjunction with FIG. 2, the content items include content for presentation to the users and a bid amount that specifies an amount of compensation the publishing user provides the online system 140 when the content item is presented to a user or when a user to whom the content item was presented performs a particular action. For example, the bid amounts specifies a maximum amount of compensation the publishing user provides the online system 140 each time the content item is presented to a user. As another example, the bid amount specifies a maximum amount of compensation the publishing user provides the online system 140 for each specific interaction performed by a user to whom the content item was presented. In various embodiments, the content item includes an objective specifying an action the publishing user desires a user to perform after being presented with the content item, so the bid amount indicates a maximum amount of compensation the publishing user provides the online system 140 when a user presented with the content item performs the action specified by the objective.

The publishing user may provide the content item to the online system 140 in various embodiments. Alternatively, the online system 140 prompts the publishing user to provide components of the content item, and generates the content item form the provided components. For example, the online system 140 prompts the user to provide images, video, text, or other content for presentation to other users, as well as the bid amount via one or more prompts. Based on the provided information, the online system 140 generates and stores the content item.

Additionally, the online system 140 receives 310 a budget associated with the content item from the publishing user. The budget specifies a maximum amount of compensation the publishing user provides the online system 140 for presenting the content item to users during a specific time interval. For example, the budget specifies a maximum amount of compensation the online system 140 receives from the publishing user during a one month time interval in exchange for presentation of the content item to users during the one month time interval. As further described above in conjunction with FIG. 2, when the online system 140 receives an amount of compensation from the publishing user during the specific time interval of the budget, the online system 140 withholds subsequent presentation of the content item to users during the specific time interval. Hence, the budget allows the publishing user to limit an amount provided to the online system 140 for presenting the content item.

However, the publishing user often has limited information for determining the budget associated with the content item, which may limit the effectiveness of presentation of the content item to users by the online system 140 in enticing online system users to perform actions when presented with the content item. For example, the publishing user specifies a low amount for a budget for presenting the content item, reducing a number of times the content item is presented to users by the online system 140. If the content item is successful in causing users to perform actions after presentation, the low budget limits a number of actions performed by users by limiting a number of users to whom the content item was presented during the specific time interval corresponding to the budget. Conversely, if a content item is ineffective in causing users to perform actions after presentation, the publishing user may specify a budget that is too large, which causes the publishing user to provide the online system 140 with compensation that is disproportionate to the number of actions performed by users who were presented with the content item during the specific time interval.

To allow the publishing user to refine the budget associated with the content item, the online system 140 leverages information about online system users and content items presented to the online system users to provide the publishing user with estimated actions performed by users to whom the content item was presented. By presenting the publishing user with the estimated actions, the online system 140 allows the publishing user to refine the budget for presenting the content item during a specific time interval to most effectively present the content item to users to encourage user actions. To provide the publishing user with information estimating actions performed by users to whom the content item was presented, the online system 140 identifies 315 a set of users eligible to be presented with the content item. If the content item includes targeting criteria, the online system 140 identifies 315 the set of users as users having characteristics satisfying at least a threshold amount of the targeting criteria included in the content item. The online system 140 may use characteristics of the content item and characteristics of various users to identify 315 the set of users. For example, the online system 140 may identify 315 users to whom at least a threshold number of content items having characteristics matching, or similar to, characteristics of the content item were presented within a time interval. As another example, the online system 140 identifies 315 users to whom at least a threshold number of content items having characteristics matching characteristics of the content item were presented and other users having at least a threshold amount of characteristics matching characteristics of the users to whom at least the threshold number of content items matching characteristics of the content item were presented. In various embodiments, the online system 140 identifies 315 the set of users to include a particular amount of users eligible to be presented with the content item.

The online system 140 determines 320 a set of alternative budgets associated with the content item, with each alternative budget differing from the received budget. In various embodiments, each alternative budget is greater than the budget received from the publishing user and associated with the content item. Alternatively, the alternative budgets of the set are both greater than and less than the budget a that are each greater than the budget received from the publishing user and associated with the content item. In various embodiments, the online system 140 determines 320 the alternate budgets by modifying the budget received from the publishing user by various amounts. For example, the online system 140 increases (or decreases) the budget received from the publishing user by different percentages to determine 320 alternative budgets of the set. As another example, the online system 140 increases (or decreases) the budget received from the publishing user by different amounts. Each alternative budget corresponds to the specific time interval specified by the budget.

For each of the alternative budgets and for the budget, the online system 140 determines 325 an estimated number of actions performed by users when presented with the content item. To determine the estimated number of actions for an alternative budget or for the budget, the online system 140 applies one or more models to characteristics of users of the identified set, characteristics of the content item, and the alternative budget (or the budget). The one or more models are machine learned models trained from prior presentation of content items to various online system users, and estimate whether a user presented with the content item performs one or more actions based on characteristics of the users and characteristics of the content item, while accounting for a budget that limits presentation of the content item during the specific time interval. The one or more models may be trained using any suitable technique, and may use any suitable combination of characteristics of users or characteristics of the content item to predict whether a user of the set would perform an action after being presented with the content item. In various embodiments, the online system 140 determines 325 an estimated number of an action specified by an objective included in the particular content item specifying actions for each of multiple alternative budgets.

The online system 140 communicates 330 information identifying each alternative budget and the estimated number of actions associated with each alternative budget to a client device 110 for presentation to the publishing user. In various embodiments, the online system 140 communicates 330 a graph illustrating different alternative budgets with their corresponding estimated number of actions. The information communicated 330 to the client device 110 identifies the budget received 310 from the publishing user as well as the estimated number of actions corresponding to the budget received 310 from the publishing user in various embodiments, allowing the publishing user to more easily identify changes in the estimated number of actions for alternative budgets relative to the estimated number of actions for the budget. Alternatively, the online system 140 communicates 330 a table identifying the received budget and its corresponding estimated number of actions and identifying various alternative budgets and their corresponding estimated number of actions to the client device 110 for presentation to the publishing user.

In various embodiments, the online system 140 determines an accuracy of the model for estimating actions performed by users and communicates 330 the information identifying the budget and alternative budgets in association with their corresponding estimated numbers of actions to the client device 110 in response to the accuracy of the model equaling or exceeding a threshold. If the accuracy of the model is less than the threshold, the online system 140 withholds communication of the information identifying the budget and additional budgets, as well as their corresponding estimated actions, to the client device 110. This allows the online system 140 to limit presentation of estimated numbers of actions corresponding to different budgets to numbers of actions that have been determined 325 with at least a threshold accuracy, limiting information provided to the publishing user to estimated numbers of actions most likely to provide the publishing user with information most likely to accurately estimate actions performed by users to whom the content item is presented.

To determine the accuracy of a model estimating actions of users performed by users to whom the content item is presented, in various embodiments, the online system 140 determines a ratio of the estimated number of an action estimated by the model performed by users when presented with the content item for an alternative budget. Additionally, the online system 140 determines a number of the action estimated by the model that were performed by users to whom a content item having at least a threshold amount of characteristics matching characteristics of the content item and who have at least a threshold number of characteristics matching characteristics of users of the identified set. The online system 140 determines a ratio of the number of the estimated number of the action estimated by the model to the number of the action estimated by the model that were performed. Similarly, the online system 140 determines an additional ratio of the number of the action estimated by the model that were performed to the estimated number of the action estimated by the model. The online system 140 determines an error or the model as a maximum of the ratio and the additional ratio. If the determined error is less than an error threshold, the online system 140 communicates 330 the information identifying the alternative budgets, the budget, and their corresponding estimated numbers of actions to the client device 110 for presentation to the publishing user; however, if the determined error equals or exceeds the error threshold, the online system 140 withholds communication of the information identifying the alternative budgets, the budget, and their corresponding estimated numbers of actions to the client device 110.

Additionally, the online system 140 may identify an optimum alternative budget of the set to the publishing user in various embodiments. The optimum alternative budget corresponds to a maximum number of estimated actions occurring before increased alternative budgets correspond to decreased numbers of estimated actions, allowing the online system 140 to identify an alternative budget estimated to result in an optimum number of actions for the publishing user when used to present the content item to users. To identify the optimum alternative budget, the online system 140 determines rates of changes of the estimated number of actions with respect to changes in the alternative budget. For example, the online system 140 determines values derivative of a function of the estimated number of actions based on the alternative budgets for different alternative budgets. Based on the determined rates of change of the estimated number of actions, the online system 140 identifies the optimum alternative budget of the set of alternative budgets. In various embodiments, the online system 140 identifies the optimum alternative budget by selecting an alternative budget associated with a rate of change of the estimated number of actions that is less than a threshold value and determines a rate at which the rate of change of the estimated number of actions associated with the selected alternative budget changes. If the rate at which the rate of change of the estimated number of actions associated with the selected alternative budget changes is less than a threshold rate of change, the online system 140 identifies the selected alternative budget as the optimum budget. For example, the online system 140 selects an alternative budget where a derivative of a function of the expected number of actions relative to the alternative budgets is zero; the online system 140 determines a second derivative of the function of the expected number of actions relative to the alternative budgets and determines a values of the second derivative for the selected alternative budget. If the value of the second derivative is less than zero for the selected alternative budget, the online system 140 identifies the selected alternative budget as the optimum alternative budget. In various embodiments, the online system 140 visually distinguishes the optimum alternative budget from other alternative budgets identified to the publishing user. Identifying the optimum alternative budget allows the online system 140 to simplify potential modifications to the budget by the publishing user by identifying an alternative budget likely to provide a maximum number of actions by users relative to the alternative budget.

While FIG. 3 describes determining estimated number of actions performed by users presented with the content item, in other embodiments, the online system 140 estimates a number of unique users to whom the content item is presented for different alternative budgets and for the budget. To estimate a number of unique users to whom the content item is presented subject to an alternative budget (or subject to the budget), the online system 140 applies one or more models to characteristics of users of the set, to characteristics of the content item, and to the alternative budget (or to the budget), as described above. The online system 140 communicates information identifying the estimated number of unique users to a client device 110 for presentation to the publishing user. In some embodiments, the online system 140 limits communication of information identifying the estimated number of unique users to the client device 110 to estimated numbers of unique users determined with at least a threshold accuracy, determined as described above or identifies an optimum alternative budget for maximizing the number of unique users to whom the content item is presented, determined as described above.

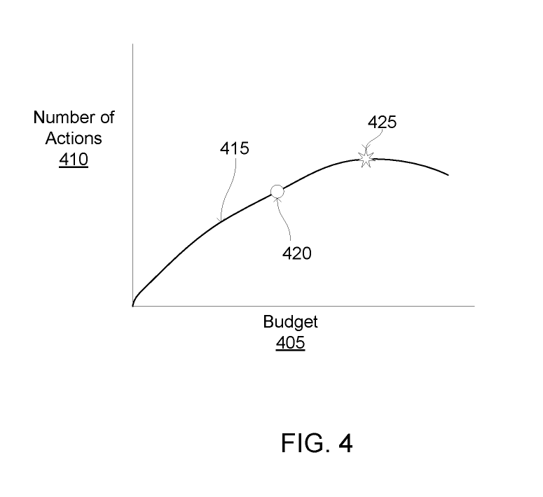

FIG. 4 shows an example of information presented to a publishing user identifying different budgets 405 and corresponding estimated numbers of actions for presenting a content item. In the example, of FIG. 4, an online system 140 communicates a graph 415 showing different budgets 405 against estimated numbers of actions 410 corresponding to various budgets 405. The graph 415 allows the publishing user to more quickly identify changes in the estimated number of actions 410 corresponding to changes in the budget 405. The graph 415 may identify the budget 420 the online system 140 received from the publishing, allowing the publishing user to readily identify the estimated number of actions 410 if the content item is presented subject to the received budget for evaluating against alternative budgets 405. Additionally, the example shown by FIG. 4 visually distinguishes an optimum alternative budget 425 from other budgets 405, allowing the publishing user to more easily identify an alternative budget likely to result in an optimal number of estimated actions. Determination of the optimum alternative budget 425 is further described above in conjunction with FIG. 3. Hence, the information presented to the publishing user allows the publishing user to more easily evaluate how different budgets affect likely numbers of actions 410 performed by users to whom the content item is presented.

### CONCLUSION

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
obtaining, at an online system, information from a publishing user identifying a content item for presentation to users of the online system, the content item including content for presentation and a bid amount specifying an amount of compensation the publishing user provides the online system for a presentation of the content item;
receiving a budget associated with the content item from the publishing user, the budget specifying a maximum amount of compensation the publishing user provides the online system during a time interval for presenting the content item to users during the time interval;
identifying a set of users of the online system eligible to be presented with the content item based on characteristics of the content item and characteristics of users maintained by the online system;
determining a set of alternative budgets associated with the consent item, each alternative budget differing from the budget received from the publishing user;
determining an estimated number of actions performed by users when presented with the content item for the budget and for each of the alternative budgets, the estimated number of actions for each alternative budget and for the budget based on characteristics of users of the identified set and characteristics of the content item; and
communicating information identifying each of the alternative budgets and the estimated number of actions associated with each alternative budget, as well as the budget and the estimated number of actions associated with the budget, to a client device for presentation to the publishing user.

2. The method of claim 1, wherein determining the estimated number of actions performed by users when presented with the content item for the budget and to each of the alternative budgets comprises:
applying a model to characteristics of users of the set, characteristics of the content item, and to the alternative budget; and
applying the model to characteristics of users of the set, characteristics of the content item, and to the budget.

3. The method of claim 2, wherein communicating information identifying each of the alternative budgets and the estimated number of actions associated with each alternative budget as well as the budget and the estimated number of actions associated with the budget comprises:
determining an accuracy of the model based on actions performed by users having at least a threshold amount of characteristics matching characteristics of users of the set who were presented with one or more content items having at least a threshold amount of characteristics matching characteristics of the content item; and
communicating information identifying each of the alternative budgets and the estimated number of actions associated with each alternative budget and associated with the budget in response to determining the accuracy of the model equals or exceeds a threshold.

4. The method of claim 3, wherein communicating information identifying each of the alternative budgets and the estimated number of actions associated with each alternative budget, as well as the budget and the estimated number of actions associated with the budget comprises:
withholding communication of information identifying each of the alternative budgets, the estimated number of actions associated with each alternative budget, as well as the budget and the estimated number of actions associated with the budget in response to determining the accuracy of the model does not equal or exceed the threshold.

5. The method of claim 3, wherein determining the accuracy of the model based on actions performed by users having at least a threshold amount of characteristics matching characteristics of users of the set who were presented with one or more content items having at least a threshold amount of characteristics matching characteristics of the content item comprises:
determining a ratio of the estimated number of actions performed by users when presented with the content item for one or more of the alternative budgets and for the budget to a number actions performed by users having at least a threshold amount of characteristics matching characteristics of users of the set who were presented with one or more content items having at least a threshold amount of characteristics matching characteristics of the content item for one or more of the alternative budgets and the budget;
determining an additional ratio of the number of actions performed by users having at least a threshold amount of characteristics matching characteristics of users of the set who were presented with one or more content items having at least a threshold amount of characteristics matching characteristics of the content item for one or more of the alternative budgets to the estimated number of actions performed by users when presented with the content item for one or more of the alternative budgets and the budget; and
determining an error of the model as a maximum of the ratio and the additional ratio.

6. The method of claim 5, wherein communicating information identifying each of the alternative budgets and the estimated number of actions associated with each alternative budget, as well as the budget and the estimated number of actions associated with the budget comprises:
communicating information identifying each of the alternative budgets, the estimated number of actions associated with each alternative budget, as well as the budget and the estimated number of actions associated with the budget, in response to determining the error of the model is less than an error threshold.

7. The method of claim 1, further comprising:
determining rates of change of the estimated number of actions with respect to changes in in the alternative budgets;
identifying an optimum alternative budget of the set of alternative budget based on the rates of change.

8. The method of claim 7, wherein identifying the optimum alternative budget of the set of alternative budget based on the rates of change comprises:
selecting an alternative budget associated with a rate of change of the estimated number of actions less than a threshold value;
determining a rate at which the rate of change of the estimated number of actions associated with the selected alternative budget changes; and
identifying the selected alternative budget in response to the rate at which the rate of change of the estimated number of actions associated with the selected alternative budget changes being less than a threshold rate of change.

9. The method of claim 1, wherein the content item includes an objective identifying a desired action by the publishing user.

10. The method of claim 9, wherein determining the estimated number of actions performed by users when presented with the content item for each of the alternative budgets comprises:
determining an estimated number of the desired action identified by the objective performed by users when presented with the content item for each of the alternative budgets.

11. A computer program product comprising a computer readable storage medium having instructions encoded thereon that, when executed by a processor, cause the processor to:
obtain, at an online system, information from a publishing user identifying a content item for presentation to users of the online system, the content item including content for presentation and a bid amount specifying an amount of compensation the publishing user provides the online system for a presentation of the content item;
receive a budget associated with the content item from the publishing user, the budget specifying a maximum amount of compensation the publishing user provides the online system during a time interval for presenting the content item to users during the time interval;
identify a set of users of the online system eligible to be presented with the content item based on characteristics of the content item and characteristics of users maintained by the online system;
determine a set of alternative budgets associated with the consent item, each alternative budget differing from the budget received from the publishing user;
determine an estimated number of actions performed by users when presented with the content item for the budget and for each of the alternative budgets, the estimated number of actions for each alternative budget and for the budget based on characteristics of users of the identified set and characteristics of the content item; and
communicate information identifying each of the alternative budgets and the estimated number of actions associated with each alternative budget, as well as the budget and the estimated number of actions associated with the budget, to a client device for presentation to the publishing user.

12. The computer program product of claim 11, wherein determine the estimated number of actions performed by users when presented with the content item for the budget and to each of the alternative budgets comprises:
apply a model to characteristics of users of the set, characteristics of the content item, and to the alternative budget; and
apply the model to characteristics of users of the set, characteristics of the content item, and to the budget.

13. The computer program product of claim 12, wherein communicate information identifying each of the alternative budgets and the estimated number of actions associated with each alternative budget as well as the budget and the estimated number of actions associated with the budget comprises:
determine an accuracy of the model based on actions performed by users having at least a threshold amount of characteristics matching characteristics of users of the set who were presented with one or more content items having at least a threshold amount of characteristics matching characteristics of the content item; and
communicate information identifying each of the alternative budgets and the estimated number of actions associated with each alternative budget and associated with the budget in response to determining the accuracy of the model equals or exceeds a threshold.

14. The computer program product of claim 13, wherein communicate information identifying each of the alternative budgets and the estimated number of actions associated with each alternative budget, as well as the budget and the estimated number of actions associated with the budget comprises:
withholding communication of information identifying each of the alternative budgets, the estimated number of actions associated with each alternative budget, as well as the budget and the estimated number of actions associated with the budget in response to determining the accuracy of the model does not equal or exceed the threshold.

15. The computer program product of claim 13, wherein determine the accuracy of the model based on actions performed by users having at least a threshold amount of characteristics matching characteristics of users of the set who were presented with one or more content items having at least a threshold amount of characteristics matching characteristics of the content item comprises:
determine a ratio of the estimated number of actions performed by users when presented with the content item for one or more of the alternative budgets and for the budget to a number actions performed by users having at least a threshold amount of characteristics matching characteristics of users of the set who were presented with one or more content items having at least a threshold amount of characteristics matching characteristics of the content item for one or more of the alternative budgets and the budget;
determine an additional ratio of the number of actions performed by users having at least a threshold amount of characteristics matching characteristics of users of the set who were presented with one or more content items having at least a threshold amount of characteristics matching characteristics of the content item for one or more of the alternative budgets to the estimated number of actions performed by users when presented with the content item for one or more of the alternative budgets and the budget; and
determine an error of the model as a maximum of the ratio and the additional ratio.

16. The computer program product of claim 15, wherein communicate information identifying each of the alternative budgets and the estimated number of actions associated with each alternative budget, as well as the budget and the estimated number of actions associated with the budget comprises:
communicate information identifying each of the alternative budgets, the estimated number of actions associated with each alternative budget, as well as the budget and the estimated number of actions associated with the budget, in response to determining the error of the model is less than an error threshold.

17. The computer program product of claim 11, wherein the computer readable storage medium further has instructions encoded thereon that, when executed by the processor, cause the processor to:
determine rates of change of the estimated number of actions with respect to changes in in the alternative budgets; and
identify an optimum alternative budget of the set of alternative budget based on the rates of change.

18. The computer program product of claim 17, wherein identify the optimum alternative budget of the set of alternative budget based on the rates of change comprises:
select an alternative budget associated with a rate of change of the estimated number of actions less than a threshold value;
determine a rate at which the rate of change of the estimated number of actions associated with the selected alternative budget changes; and
identify the selected alternative budget in response to the rate at which the rate of change of the estimated number of actions associated with the selected alternative budget changes being less than a threshold rate of change.

19. The computer program product of claim 11, wherein the content item includes an objective identifying a desired action by the publishing user.

20. The computer program product of claim 19, wherein determine the estimated number of actions performed by users when presented with the content item for each of the alternative budgets comprises:
determine an estimated number of the desired action identified by the objective performed by users when presented with the content item for each of the alternative budgets.
